(19) United States
(12) Patent Application Publication
(10) Pub. No.: US 2016/0253647 A1
(43) Pub. Date: Sep. 1, 2016

(54) CHECKOUT SYSTEM, COMMODITY REGISTRATION DEVICE, AND CONTROL METHOD THEREOF

(71) Applicant: TOSHIBA TEC KABUSHIKI KAISHA, Tokyo (JP)

(72) Inventors: Tsuyoshi GOTANDA, Ota Tokyo (JP); Akiko SUSAKI, Ota Tokyo (JP); Nobuhiro SUGITA, Mishima Shizuoka (JP)

(21) Appl. No.: 15/045,913

(22) Filed: Feb. 17, 2016

(30) Foreign Application Priority Data
Feb. 27, 2015 (JP) 2015-039166

(51) Int. Cl. G06Q 20/20; G06F 3/0484; G06F 3/0482

(52) U.S. Cl. CPC G06Q 20/204; G06Q 20/208; G06F 3/0482; G06F 3/04842; G06F 3/04845

(57) ABSTRACT

In one embodiment, a checkout system has at least one commodity registration device and a plurality of settlement devices. The commodity registration device makes a guide screen to be displayed on the display, the guide screen including a layout image indicating an arrangement position of the commodity registration device and arrangement positions of the plurality of settlement devices, and a route image indicating a route from the arrangement position of the commodity registration device to the arrangement position of the settlement device which is made to perform a settlement processing.

### CROSS-REFERENCE TO RELATED APPLICATION

This application is based upon and claims the benefit of priority from the prior Japanese Patent Application No. 2015-039166, filed on Feb. 27, 2015, the entire contents of which are incorporated herein by reference.

### FIELD

Embodiments described herein relate generally to a checkout system, a commodity registration device, and a control method thereof.

### BACKGROUND

A checkout system which performs a registration processing of a purchased commodity and a settlement processing of a purchased commodity in a store such as a supermarket is known. The above-described checkout system has a commodity registration device which performs a registration processing of a purchased commodity, and a settlement device which is a device different from this commodity registration device, and performs a settlement processing of a purchased commodity. In the above-described checkout system, a system in which an employee performs an operation of the commodity registration device, and a shopper performs an operation of the settlement device is especially called a checkout system of a semi-self type.

In the above-described checkout system of a semi-self type, settlement information for settlement processing is transferred from a commodity registration device to a settlement device in an empty state. For this reason, when a plurality of settlement devices are provided for one commodity registration device, it is necessary for an employee to inform a shopper of the settlement device to which the settlement information has been transferred.

Conventionally, an employee orally informs a shopper of the settlement device to which the settlement information has been transferred. But when informed only orally, it is likely that the shopper cannot grasp easily and accurately the settlement device which the shopper operates for settlement processing.

### BRIEF DESCRIPTION OF THE DRAWINGS

FIG. 1 is a plan view showing a checkout system according to an embodiment.

FIG. 2 is a block diagram showing the commodity registration devices and the settlement devices according to the embodiment.

FIG. 3 is a flow chart showing a control processing of the commodity registration device according to the embodiment.

FIG. 4 is a flow chart showing the control processing of the commodity registration device according to the embodiment.

FIG. 5 is a diagram showing an example of a registration screen which the touch panel of the commodity registration device according to the embodiment displays.

FIG. 6 is a diagram showing an example of a first selection screen which the touch panel of the commodity registration device according to the embodiment displays.

FIG. 7 is a diagram showing an example of a second selection screen which the touch panel of the commodity registration device according to the embodiment displays.

FIG. 8 is a diagram showing an example of a guide screen which the guide display of the commodity registration device according to the embodiment displays.

FIG. 9 is a diagram showing an example of a guide screen which the guide display of the commodity registration device according to the embodiment displays.

FIG. 10 is a diagram showing an example of a notification screen which the touch panel of the commodity registration device according to the embodiment displays.

FIG. 11 is a flow chart showing a control processing of the settlement device according to the embodiment.

### DETAILED DESCRIPTION

According to one embodiment, a checkout system has at least one commodity registration device and a plurality of settlement devices. The commodity registration device is arranged in a store, and performs a registration processing of a purchased commodity. The settlement device is arranged in the store, and performs a settlement processing of the purchased commodity subjected to the registration processing by the commodity registration device. Further, the commodity registration device has a selection button, a display, and a processor. The selection button accepts an operation for selecting any one settlement device out of the plurality of settlement devices, as the settlement device which is made to perform the settlement processing. The display displays a guide screen relating to the settlement processing. The processor makes the guide screen to be displayed on the display, the guide screen including layout images indicating an arrangement position of the commodity registration device and arrangement positions of the plurality of settlement devices in the store, and a route image indicating a route in the store from the arrangement position of the commodity registration device to the arrangement position of the settlement device selected by the accepted operation.

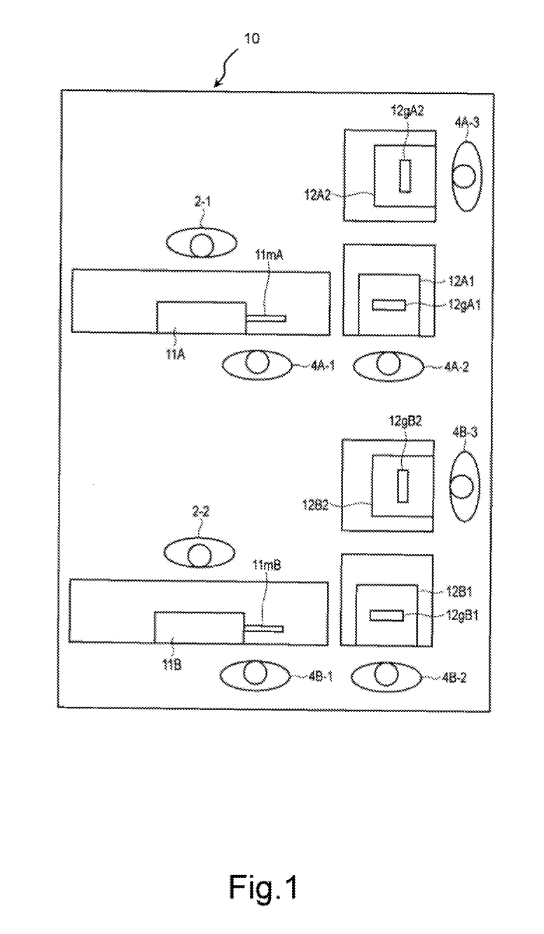

Hereinafter, embodiments will be described with reference to the drawings. In the drawings, the same symbols indicate the same or similar portions. A checkout system 10 in the present embodiment is installed at a checkout corner in a store such as a supermarket, for example. The checkout system 10 includes a commodity registration device 11 (11A, 11B) and a plurality of settlement devices 12 (12A1, 12A2, 12B1, 12B2). FIG. 1 is a plan view showing a layout, in the above-described checkout corner, of the commodity registration device 11 and a plurality of the settlement devices 12 in the checkout system of the present embodiment. As shown in FIG. 1, two commodity registration devices 11A, 11B are arranged in the checkout corner. In addition, two settlement devices 12A (12A1, 12A2) are arranged in the vicinity of the commodity registration device 11A. Two settlement devices 12B (12B1, 12B2) are arranged in the vicinity of the commodity registration device 11B.

The commodity registration device 11A performs a registration processing of a commodity (purchased commodity) which a shopper 4A-1 tries to purchase in FIG. 1, and generates registration information of the purchased commodity subjected to the registration processing. This generated registration information is stored in a registered commodity table described later. Further, the commodity registration device 11A generates settlement information described later, based on the above-described registration information. The commodity registration device 11A transfers the settlement information to the settlement device 12A, in a semi-self mode (a state in which the semi-self mode is ON). The commodity registration device 11A transfers the settlement information, and thereby can make the settlement device 12A perform a settlement processing based on the settlement information. The commodity registration device 11A is operated by an employee 2-1 in charge of commodity registration who is called a checker. In addition, in a cashier mode (a state in which the semi-self mode is OFF), the commodity registration device 11A performs the same settlement processing as the settlement device 12, based on the settlement information, by an operation of the checker. In addition, also in the cashier mode, the commodity registration device 11A can transfer the settlement information to the settlement device 12A, as described later.

Each of the settlement devices 12A1, 12A2 receives the settlement information generated by the commodity registration device 11A, and performs a settlement processing based on this settlement information. The settlement devices 12A1, 12A2 are operated by shoppers 4A-2, 4A-3 in FIG. 1, respectively. In addition, the settlement devices 12A1, 12A2 may be operated by the employee 2-1, in place of the shoppers 4A-2, 4A-3.

The commodity registration device 11A is attached to a work table, in FIG. 1. The work table has a rectangular top plate, for example. The commodity registration device 11A has a scanner 11f as described later. The employee 2-1 holds the purchased commodity of the shopper 4A-1 in front of the scanner 11f on the work table, to perform an operation for registration processing of the purchased commodity. The scanner 11f scans the above held purchased commodity. The commodity registration device 11A performs a registration processing of the purchased commodity using the scanner 11f. The commodity registration device 11A has a display 11mA as a guide display for the shopper 4 (4A-1). The display 11mA is arranged so that a display screen faces the shopper 4A-1, and displays a guide screen including information to be presented to the shopper 4A-1 in FIG. 1. For example, the display 11mA displays a guide screen including information (a name, a price, and so on) of the commodity subjected to the registration processing as the purchased commodity. Further, the display 11mA displays a guide screen describe later, or the like, including a layout image indicating an arrangement position of the commodity registration device 11A and an arrangement position of the settlement device 12, and a route image indicating a route from the arrangement position of the commodity registration device 11A to the arrangement position of the settlement device 12. In addition, the display 11mA may have a touch panel function, in the same manner as an operation display for the employee 2-1 described later, or a display of the settlement device described later.

The settlement devices 12A1, 12A2 are arranged near the work table to which the commodity registration device 11A is attached, for example. In FIG. 1, an example has been shown in which the two settlement devices 12A1, 12A2 are arranged, but the three or more settlement devices 12 may be provided. The settlement devices 12A1, 12A2 have touch panels 12gA1, 12gA2 as operation displays for shoppers 4A-2, 4A-3, respectively. The touch panels 12gA1, 12gA2 each include a display device and a touch sensor. The touch panels 12gA1, 12gA2 each display an operation screen of settlement processing toward a shopper. In addition, when the settlement devices 12A1, 12A2 are each operated by the employee 2-1 in place of the shopper 4, it is possible to change the direction of the device so that the operation screen of settlement processing is displayed toward the employee 2-1.

The commodity registration device 11B performs a registration processing of a purchase commodity of a shopper 4B-1, and generates registration information of the purchased commodity. Further, the commodity registration device 11B generates settlement information of the purchased commodity, based on the above-described registration information. The commodity registration device 11B transfers this settlement information to the settlement device 12B, in the semi-self mode. The commodity registration device 11B is operated by an employee 2-2 who is a checker in FIG. 1. In addition, the commodity registration device 11B performs the same settlement processing as the settlement device 12B by an operation of the checker, based on the above-described settlement information, in the cashier mode.

The settlement device 12B receives the registration information generated by the commodity registration device 11B, and performs a settlement processing based on this registration information. The settlement device 12B is operated by the shopper 4 (4B-2, 4B-3). In addition, the settlement device 12B may be operated by an employee 2-2 in place of the shopper 4.

Since the commodity registration device 11B has the same configuration as the commodity registration device 11A, the detailed description thereof will be omitted. The commodity registration device 11B has a display 11mB similarly as the commodity registration device 11A. The display 11mB displays a guide screen or the like including information to be presented to the shopper 4B-1.

Since the settlement devices 12B1, 12B2 have the same configurations as the settlement devices 12A1, 12A2, the detailed description thereof will be omitted. The settlement devices 12B1, 12B2 respectively have, as displays for settlement processing, touch panels 12gB1, 12gB2 each including a display device and a touch sensor.

In addition, in the checkout system 10 in the present embodiment, the number of the commodity registration devices is not limited. In addition, the settlement information generated by the commodity registration device 11 is basically transferred to the settlement device 12 which is installed in the vicinity of the commodity registration device 11 which has generated the settlement information. Accordingly, the settlement processing in the semi-self mode is performed in the above-described settlement device 12 installed in the vicinity. In addition, the above-described settlement information may be transferred to the settlement device 12 which is installed at a place distant from the commodity registration device 11 which has generated the settlement information. In this case, the settlement processing is also performed in the settlement device 12 installed at the above distant place. For example, the settlement processing based on the settlement information generated by the commodity registration device 11A may be executed by the settlement device 12B1 or the settlement device 12B2.

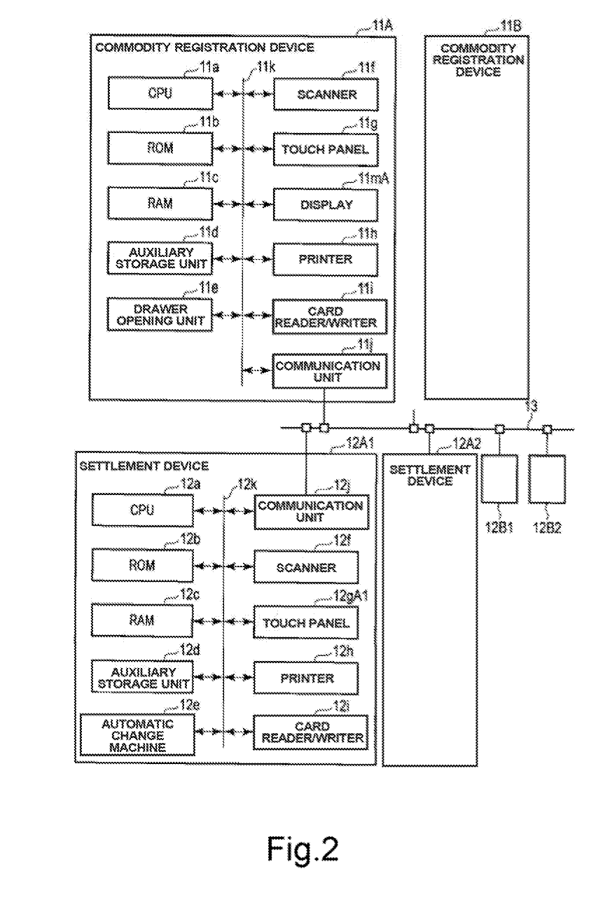

FIG. 2 is a block diagram showing the commodity registration device 11 and the settlement device 12 in the present embodiment.

The commodity registration devices 11A, 11B and the settlement devices 12A1, 12A2, 12B1, 12B2 are all connected to a LAN (local area network) 13. The connection of the commodity registration devices 11A, 11B and the settlement devices 12A1, 12A2, 12B1, 12B2 can be made using Internet or another communication network such as a wireless LAN, in place of the LAN 13. Or, the commodity registration devices 11A, 11B and the settlement devices 12A1, 12A2, 12B1, 12B2 may transmit and receive information via a server.

The commodity registration device 11A includes a processor 11a, a ROM (read-only memory) 11b, a RAM (random-access memory) 11c, an auxiliary storage unit 11d, a drawer opening unit 11e, the scanner 11f, a touch panel 11g, a printer 11h, a card reader/writer 11i, a communication unit 11j, a transmission system 11k, and the display 11mA.

The processor 11a, the ROM 11b, the RAM 11c and the auxiliary storage unit 11d are connected by the transmission system 11k, to compose a computer.

The processor 11a is a CPU (central processing unit), for example. In the following description, the processor 11a is called a CPU 11a. The CPU 11a corresponds to a central portion of the above-described computer. The CPU 11a controls the respective units of the commodity registration device 11, based on an operating system, a middleware and an application program which are stored in the ROM 11b and the RAM 11c, so as to realize various operations as the commodity registration device 11.

The ROM 11b corresponds to a main storage portion of the above-described computer. The ROM 11b stores the above-described operating system. The ROM 11b may store the above-described middleware and application program. In addition, the ROM 11b may store data to which the CPU 11a refers when performing various processings.

The RAM 11c corresponds to the main storage portion of the above-described computer. The RAM 11c stores data to which the CPU 11a refers when performing various processings. Further, the RAM 11c is used as a so-called work area to store data which the CPU 11a temporally uses when performing various processings.

The auxiliary storage unit 11d corresponds to an auxiliary storage portion of the above-described computer. The auxiliary storage unit 11d stores data which the CPU 11a uses when performing various processings, or data generated by the processing in the CPU 11a. As the auxiliary storage unit 11d, an EEPROM (electric erasable programmable read-only memory), an HDD (hard disk drive), or an SSD (solid state device) or the like can be used, for example. In addition, the ROM 11b or the auxiliary storage unit 11d stores data of a layout image indicating an arrangement position of the commodity registration device 11 and arrangement positions of a plurality of the settlement devices 12 in the store, for example. Further, the ROM 11b or the auxiliary storage unit 11d stores data of a route image indicating a route in the store, from the arrangement position of the commodity registration device 11 to the arrangement position of the settlement device 12. For example, the CPU 11a makes each of the guide displays 11ma, 11mB display the layout image described later and the route image described later, based on the data of the above-described image stored in the ROM 11b or the auxiliary storage unit 11d.

The application program to be stored in the ROM 11b or the auxiliary storage unit 11d includes a control program describing a control processing described later. Assignment of the commodity registration device 11 is generally performed in a state that the control program is stored in the ROM 11b or the auxiliary storage unit 11d. The commodity registration device 11 may be assigned in a state that the control program is not stored in the ROM 11b or the auxiliary storage unit 11d. In this case, the control program may be assigned separately from the commodity registration device 11, in a state stored in a removable recording medium, or via a network. The removable recording medium includes a magnetic disk, a magneto optical disk, an optical disk, a semiconductor memory, or the like. The control program to be assigned via a network is written into the auxiliary storage unit 11d of the commodity registration device 11.

The drawer opening unit 11e automatically opens a drawer for housing a coin.

The scanner 11f scans a commodity, to read the information of the commodity. The information of the commodity includes a commodity code of the relevant commodity, for example. Accordingly, the scanner 11f reads the information of the commodity, to obtain the commodity code of the relevant commodity. As the scanner 11f, scanners of well-known various types can be used without change. The scanner 11f may correspond to only one out of the well-known various types, or may correspond to a plurality of types. That is, the scanner 11f may include a fixed type or a handy type two-dimensional scanner. In addition, the scanner 11f may include one having a type to discriminate a commodity from an image of the commodity, using an image recognition technology.

The touch panel 11g includes a display device and a touch sensor. The display device displays an optional screen such as a GUI screen, as its display screen. As the display device, a well-known device can be used, such as a color LCD (Liquid Crystal Display), for example. The touch sensor is arranged to be superposed on a display surface of the display device. The touch sensor detects a position of a touch operation (hereinafter, simply called an operation) by an operator to the display surface of the display device, and transmits its position information to the CPU 11a. As the touch sensor, a well-known device can be used.

The printer 11h is a thermal printer or a dot impact printer or the like, for example. The printer 11h prints various character strings, an image or the like on a receipt sheet, to issue a receipt.

The card reader/writer 11j reads data recorded in a card, and writes data in the above-described card. The card includes a settlement card such as a credit card, a debit card, an electronic money card, a prepaid card, and in addition, includes various cards to record information relating to settlement processing, such as a membership card and a point card. The card reader/writer 11j may be any device of a magnetic type, a contact type, or a non-contact type, and may include a plurality of kinds of devices.

The communication unit 11j performs communication via the LAN 13.

The transmission system 11k transmits data to be transmitted and received among the CPU 11a, the ROM 11b, the RAM 11c, the auxiliary storage unit 11d, the drawer opening unit 11e, the scanner 11f, the touch panel 11g, the printer 11h, the card reader/writer 11i, and the communication unit 11j. As the transmission system 11k, a well-known one including various buses such as a system bus, and various interface circuits to connect these buses with the respective units can be used.

As the display 11mA, a well-known device such as a color LCD can be used, for example. The display 11mA displays to the shopper 4-1, a guide screen including the information of the commodity subjected to registration processing as the purchased commodity, and a guide screen including a route image or the like indicating a route from the arrangement position of the commodity registration device to the arrangement position of the settlement device 12, as described above.

IN addition, as a hardware of the commodity registration device 11A, it is possible to use an existing POS (Point Of Sale) terminal, for example. Since the commodity registration device 11B has the same configuration as the commodity registration device 11A, the detailed description thereof will be omitted.

The settlement device 12A1 includes a processor 12a, a ROM 12b, a RAM 12c, an auxiliary storage unit 12d, an automatic change machine 12e, a scanner 12f, the touch panel 12gA1, a printer 12h, a card reader/writer 12i, a communication unit 12j, and a transmission system 12k.

The processor 12a, the ROM 12b, the RAM 12c and the auxiliary storage unit 12d are connected by the transmission system 12k, to compose a computer.

The processor 12a is a CPU, for example. In the following description, the processor 12a is called a CPU 12a. The CPU 12a corresponds to a central portion of the above-described computer. The CPU 12a controls the respective units of the settlement device 12A1, based on an operating system, a middleware and an application program which are stored in the ROM 12b and the RAM 12c, so as to realize various operations as the settlement device 12A1.

The ROM 12b corresponds to a main storage portion of the above-described computer. The ROM 12b stores the above-described operating system. The ROM 12b may store the above-described middleware and application program. In addition, the ROM 12b may store data to which the CPU 12a refers when performing various processings.

The RAM 12c corresponds to the main storage portion of the above-described computer. The RAM 12c stores data to which the CPU 11a refers when performing various processings. Further, the RAM 12c is used as a so-called work area to store data which the CPU 12a temporally uses when performing various processings.

The auxiliary storage unit 12d corresponds to an auxiliary storage portion of the above-described computer. The auxiliary storage unit 12d stores data which the CPU 12a uses when performing various processings, or data generated by the processing in the CPU 12a. As the auxiliary storage unit 12d, an EEPROM, an HDD, or an SSD or the like can be used, for example.

The application program to be stored in the ROM 12b or the auxiliary storage unit 12d includes a control program describing a control processing described later. Assignment of the settlement device 12 is generally performed in a state that the control program is stored in the ROM 12b or the auxiliary storage unit 12d. The settlement device 12A1 may be assigned in a state that the control program is not stored in the ROM 12b or the auxiliary storage unit 12d. In this case, the control program may be assigned separately from the settlement device 12A, in a state stored in a removable recording medium, or via a network. The removable recording medium includes a magnetic disk, a magneto optical disk, an optical disk, a semiconductor memory, or the like. The control program to be assigned via a network may be written into the auxiliary storage unit 12d of the settlement device 12.

The automatic change machine 12e receives a coin and a bank note which are inserted therein. In addition, the automatic change machine 12e discharges a coin and a bank note as a change.

The scanner 12f scans a commodity, to read the information of the commodity. The information of the commodity includes a commodity code of the relevant commodity, for example. Accordingly, the scanner 12f reads the information of the commodity, to obtain the commodity code of the relevant commodity. As the scanner 12f, scanners of well-known various types can be used without change. The scanner 12f may correspond to only one out of the well-known various types, or may correspond to a plurality of types. That is, the scanner 12f may include a fixed type or a handy type two-dimensional scanner. In addition, the scanner 12f may include one having a type to discriminate a commodity from an image of the commodity, using an image recognition technology.

The touch panel 12gA1 includes a display device and a touch sensor. The display device displays an optional screen such as a GUI screen, as its display screen. As the display device, a well-known device such as a color LCD can be used, for example. The touch sensor is arranged to be superposed on a display surface of the display device. The touch sensor detects an operation position by an operator to the display surface of the display device, and transmits its position information to the CPU 12a. As the touch sensor, a well-known device can be used.

The printer 12h is a thermal printer or a dot impact printer or the like, for example. The printer 12h prints various character strings or an image on a receipt sheet, to issue a receipt.

The card reader/writer 12j reads data recorded in a card, and writes data in the above-described card. The card includes a settlement card such as a credit card, a debit card, an electronic money card, a prepaid card, and in addition, includes various cards for recording information relating to settlement processing, such as a membership card or a point card. The card reader/writer 12j may be any device of a magnetic type, a contact type, or a non-contact type, and may include a plurality of kinds of devices.

The communication unit 12j performs communication via the LAN 13.

The transmission system 12k transmits data to be transmitted and received among the CPU 12a, the ROM 12b, the RAM 12c, the auxiliary storage unit 12d, the automatic change machine 12e, the scanner 12f, the touch panel 12gA1, the printer 12h, the card reader/writer 12j and the communication unit 12j. As the transmission system 12k, a well-known one including various buses such as a system bus, and various interface circuits to connect these buses and the respective units can be used.

In addition, the settlement device 12A1 may have a human detection sensor or the like capable of detecting that the shopper 4A-2 has approached. Further, as a hardware of the settlement device 12A1, it is possible to use an existing self POS terminal, for example. Since the settlement devices 12A2, 12B1, 12B2 have the same configuration as the settlement device 12A1, the detailed description thereof will be omitted.

Next, an operation of the checkout system 10 configured as described above will be described. Further, the content of the control processing described later is an example, and can appropriately be used to various processings in which the same result can be obtained. In addition, in the following description, an operation of the commodity registration device 11A will be described as an example.

When the commodity registration device 11A is started up in a mode to perform a registration processing of a purchased commodity, the CPU 11a starts a control processing in accordance with the control program stored in the ROM 11b or the auxiliary storage unit 11d.

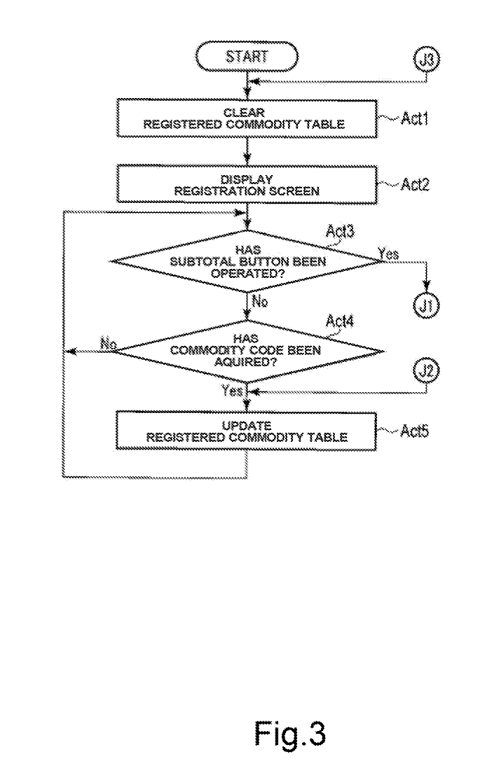

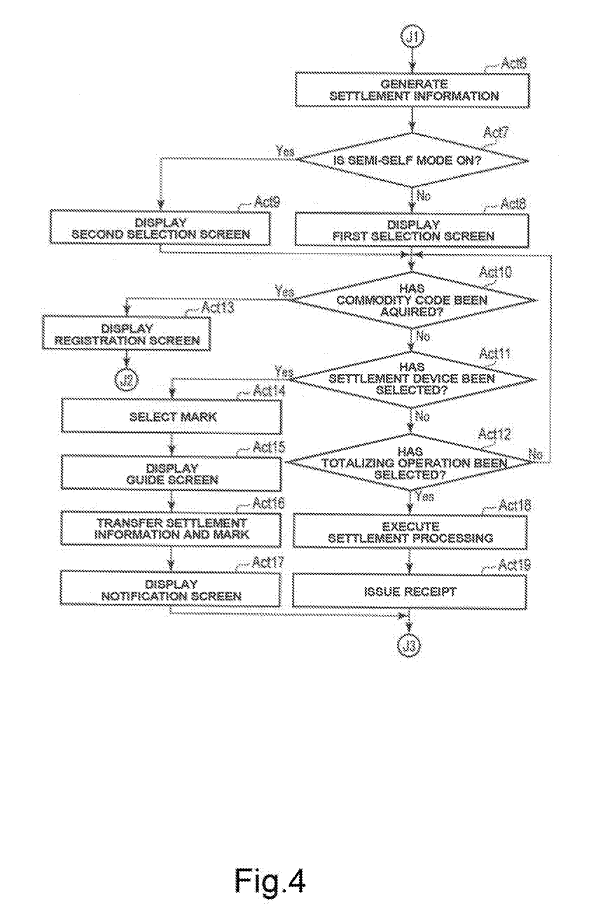

FIG. 3 and FIG. 4 are flow charts of a control processing of the CPU 11a in the present embodiment.

In Act1, the CPU 11a clears a registered commodity table to be set in the RAM 11c.

In Act2, the CPU 11a makes a registration screen to be displayed in a part of the region of the screen of the touch panel 11g. The registration screen is a screen for making the employee 2-1 confirm an implementation status of the registration processing. The registration screen displays a registration specification that is an implementation status of the registration processing, based on the content of the registered commodity table.

In other words, the registered commodity table stores an implementation status of the registration processing. The registered commodity table stores registration information of a purchased commodity, as the implementation status of the registration processing, for example. The registration information includes the above acquired commodity code, a commodity name of the purchased commodity corresponding to the commodity code, the number of the relevant purchased commodities, a unit price of the relevant purchase commodity, and a purchase money amount of the relevant purchased commodity, for example. The registered commodity table stores the number of the relevant purchased commodities, the unit price of the relevant purchase commodity, and the purchase money amount of the relevant purchased commodity, for each commodity name of the purchased commodity corresponding to the commodity code, for example.

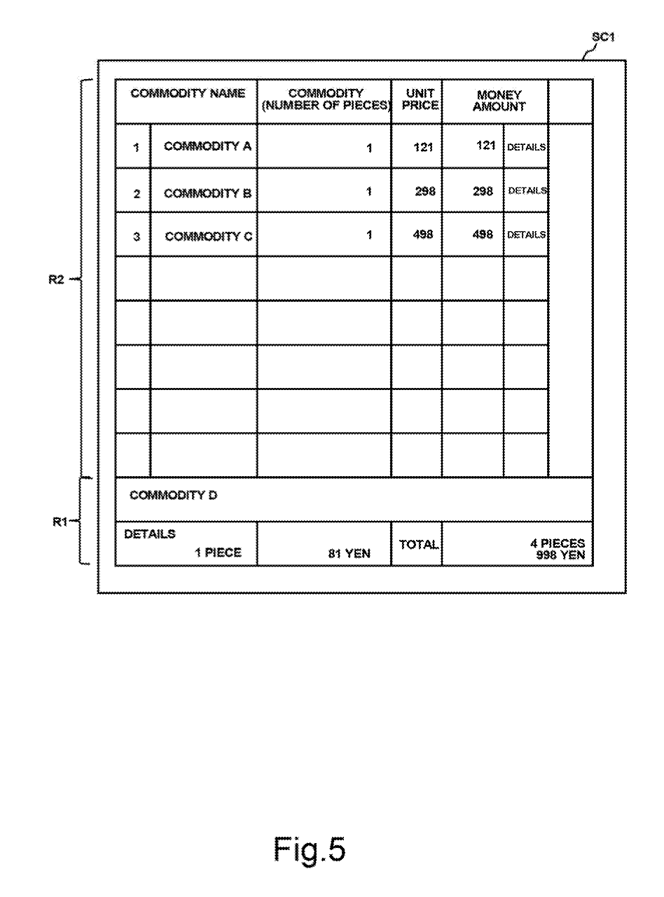

FIG. 5 is a diagram showing a registration screen SC1 as an example in the present embodiment. The registration screen SC1 includes regions R1, R2.

The region R1 is a region for displaying a commodity name, the number of pieces and a unit price relating to a purchased commodity subjected to a newest registration processing, and a total number and a total money amount of the purchased commodities after registration of the commodity. The region R2 is a region for displaying a commodity name, the number of pieces, a unit price, and a money amount relating to the purchased commodity subjected to the registration processing before the registration of the commodity displayed in the region R1 of the registration screen SC1.

In addition, FIG. 5 shows the registration screen SC1 in the state that various information relating to the purchased commodity subjected to the registration processing is displayed, but the registration screen SC1 in Act2 does not display various information relating to a commodity, but displays only a predetermined fundamental form.

In addition, the CPU 11a displays, in the screen of the touch panel 11g, a function button which accepts an operation for designating various functions by the employee 2-1, in addition to the region in which the registration screen SC1 is displayed. For example, the function button includes a commodity button which accepts an operation for designating a commodity by the employee 2-1. The function button includes a subtotal button which accepts an operation for instructing ending of the registration processing by the employee 2-1. The illustration of the function button will be omitted.

In Act3 of FIG. 3, the CPU 11a confirms whether or not the above-described subtotal button displayed in the screen of the touch panel 11g has accepted an operation of the employee 2-1. The touch sensor of the touch panel 11g detects that the subtotal button has been operated. The CPU 11a confirms whether or not the subtotal button has accepted the operation of the employee 2-1, based on the detection result of the touch sensor of the touch panel 11g. When the CPU 11a confirms that the subtotal button has not accepted the operation of the employee 2-1 (NO in Act3), the processing of the CPU 11a proceeds to Act4.

In Act4, the CPU 11a confirms whether or not a commodity code of the purchased commodity which should be subjected to the registration processing has been acquired. The purchased commodity is scanned by the scanner 11f, and thereby the commodity code is acquired, as described above. When the CPU 11a confirms that a commodity code of the purchased commodity which should be subjected to the registration processing has not been acquired (NO in Act4), the processing of the CPU 11a returns to Act3.

In this manner, the CPU 11a waits for that the subtotal button is operated, or the commodity code is acquired, in Act3 and Act4. In addition, in the waiting here, the CPU 11a confirms an occurrence of another event such that another operation is accepted, and may transfer to a processing corresponding to the occurred event.

The CPU 11a may acquire a commodity code by a well-known processing different from the control processing shown in FIG. 3 and FIG. 4, for example, based on an operation by the employee 2-1. When the CPU 11a confirms that the commodity code has been acquired (YES in Act4), the processing of the CPU 11a proceeds to Act5.

In Act5, the CPU 11a updates the registered commodity table, so that the above acquired commodity code is included in the registered commodity table. In addition, the CPU 11a updates the registration screen SC1 in accordance with the content of the registered commodity table after updating. After that, the processing of the CPU 11a returns to the waiting state of Act3 and Act4.

When the CPU 11a confirms that the above-described subtotal button has accepted the operation of the employee 2-1 (YES in Act3), the processing of the CPU 11a proceeds to Act6.

At the time point of Act6, the registration information of the purchased commodity of the above acquired commodity code is stored in the registered commodity table. In Act6, the CPU 11a generates settlement information for settlement processing of the purchased commodity, based on the registration information stored in the registered commodity table at this time point. The settlement information includes information of a list of the purchased commodity subjected to the registration processing, the total number of the purchased commodities and the total purchase money amount, and so on.

In Act7, the CPU 11a confirms whether or not the semi-self mode is ON. The semi-self mode is an operation mode of the checkout system 10 in which the commodity registration device 11A to be operated by the employee performs the registration processing of the purchased commodity, and the settlement device 12 to be operated by a shopper performs a settlement processing of the above-described purchased commodity subjected to the registration processing. The CPU 11a sets the semi-self mode to ON or OFF, by another processing different from the control processing shown in FIG. 3 and FIG. 4, based on an operation of the employee 2-1. On the other hand, when having set the semi-self mode to ON, for example, the CPU 11a sets a cashier mode to OFF. When having set the semi-self mode to OFF, for example, the CPU 11a sets the cashier mode to ON. The cashier mode is an operation mode of the commodity registration device 11A in which the commodity registration device 11A to be operated by the employee performs the registration processing of the purchased commodity, and can perform a settlement processing of the above-described purchased commodity subjected to the registration processing. In addition, in the cashier mode of the present embodiment, the commodity registration device 11A can also make the settlement device 12 perform the settlement processing of the purchased commodity, in the same manner as in the above-described semi-self mode. When the CPU 11a confirms that the semi-self mode is OFF (NO in Act7), the processing of the CPU 11a proceeds to Act8.

In Act8, the CPU 11a displays a first selection screen in a part of the region of the screen of the touch panel 11g.

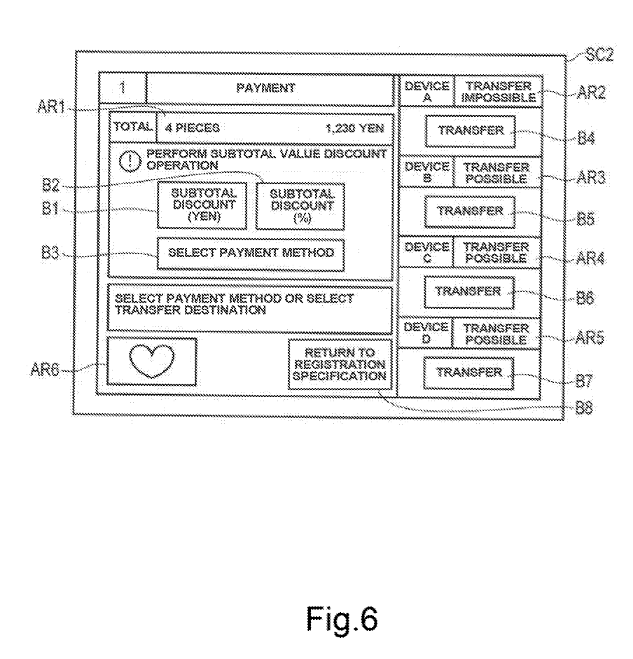

FIG. 6 is a diagram showing a first selection screen SC2 as an example in the present embodiment. The first selection screen SC2 is a selection screen when the semi-self mode is OFF (when the cashier mode is ON). With a configuration described below, the first selection screen SC2 accepts an operation by an employee for selecting a payment method so as to perform a settlement processing in the commodity registration device 11A. Further, the first selection screen SC2 accepts an operation by the employee 2-1 for selecting the settlement device 12 which is made to perform a settlement processing. The first selection screen SC2 includes display areas AR1, AR2, AR3, AR4, AR5, AR6 and buttons B1, B2, B3, B4, B5, B6, B7, B8.

The CPU 11a displays a total number of the purchased commodities and a total purchase money amount of the purchased commodities which are included in the settlement information, in the display area AR1. The CPU 11a displays proprieties of transfer of the settlement information to the four settlement devices 12, in the display areas AR2-AR5, respectively. In addition, the settlement device 12 executes a settlement processing based on the settlement information, but does not receive another settlement information, during execution of its settlement processing, until the relevant settlement processing is finished, for example. That is, the settlement device 12 becomes in a state incapable of receiving another settlement information, when executing the settlement processing. The CPU 11a makes a character string “transfer impossible”, for example, to be displayed, in the display areas AR2-AR5 associated with the settlement devices 12 in a state incapable of receiving settlement information. On the other hand, the settlement device 12 receives settlement information transferred from the commodity registration device 11A, while not executing a settlement processing. That is, the settlement device 12 becomes in a state capable of receiving settlement information, when not executing a settlement processing. The CPU 11a makes “transfer possible”, for example, to be displayed, in the display areas AR2-AR5 associated with the settlement devices 12 in a state capable of receiving settlement information. The display area AR2 is a display area associated with “a device A” corresponding to the settlement device 12A1. The display area AR3 is a display area associated with “a device B” corresponding to the settlement device 12A2. The display area AR4 is a display area associated with “a device C” corresponding to the settlement device 12B1. The display area AR5 is a display area associated with “a device D” corresponding to the settlement device 12B2. In the display areas AR2, AR3, AR4, AR5, character strings “device A”, “device B”, “device C”, “device D” expressing device names of the settlement devices are also displayed, in addition to the above-described transfer proprieties, respectively. That is, when the first selection screen SC2 of FIG. 6 is displayed in a part of the region of the screen of the touch panel 11g, the first selection screen SC2 indicates that only the settlement device 12A1 of the name called “device A” cannot receive settlement information, because it is executing the settlement processing. In other words, the first selection screen SC2 indicates that it is impossible to transmit settlement information from the commodity registration device 11A to the settlement device 12A1 of the name called “device A”.

When transferring settlement information to any one of the four settlement devices 12, the CPU 11a makes an object image to be transferred with the settlement information to the settlement device 12, to be displayed in the display area AR6. The object image is also displayed in the settlement device 12 to which the settlement information has been transferred, so as to make the shopper 4 easily grasp the settlement device 12 that is a transfer destination of the settlement information. In addition, each time the settlement information is transferred, an object image is changed so as to have a different kind, and thereby it is possible to make the shopper 4 confirm settlement information which should be subjected to an operation for settlement processing.

As the object image, an image of a shape and a color which the shopper 4 can easily discriminate, such as, a mark, a figure, an illustration, a photograph, a character is used, for example. As the mark, a heart type image, a diamond type image, a spade type image or the like is used, for example. As the illustration, an illustration image expressing an animal, such as, an elephant image, a giraffe image, a cow image, a monkey image is used, for example. The object image is an image which even a child or an elderly person can easily discriminate. In the following description, a case to use a mark will be described as an example.

The CPU 11a controls the touch panel 11g, in accordance with whether or not the settlement devices 12 associated with the buttons B4-B7 can receive settlement information from the commodity registration device 11A, and thereby changes display forms of the buttons B4-B7. For example, when the settlement devices associated with the buttons B4-B7 cannot receive the settlement information, the CPU 11a may set the display forms of the buttons B4-B7 to be non-display forms.

The buttons B1, B2 are buttons each of which accepts an operation by the employee 2-1 for designating to apply a discount to a total money amount included in the settlement information. Specifically, the button B1, for example, accepts an operation by the employee 2-1 for designating to apply a discount of a prescribed money amount to the total money amount. The button B2 accepts an operation by the employee 2-1 for designating to apply a discount of a prescribed ratio (%) to the total money amount. That is, the employee 2-1 operates any of the buttons B1, B2, and can designate one of two kinds of discounts. In the button B1, a character string “subtotal discount (yen)”, for example, is displayed. In the button B2, a character string “subtotal discount (%)”, for example, is displayed. The CPU 11a makes a message to urge the employee 2-1 to perform a discount operation of the subtotal value, such as a character string “perform subtotal value discount operation” to be displayed, in a message display area in the vicinity of the buttons B1, B2. The CPU 11a updates the total money amount included in the settlement information to a money amount in which a discount has been applied, in accordance with that the buttons B1, B2 have accepted an operation by the employee 2-1. The button B3 is a button which accepts an operation by the employee 2-1 for designating a selection processing of a payment method of a price of the purchased commodity. In the button B3, a character string “select payment method”, for example, is displayed. Further, in the present embodiment, the button B3 is also a button which accepts an operation by the employee 2-1 for designating totalizing of settlement processing. In the following description, an operation by the employee 2-1 for designating totalizing of settlement processing may be simply called a totalizing operation. The buttons B4-B7 are buttons each of which accepts an operation by the employee 2-1 for selecting any of the four settlement devices 12, as a transfer destination of the settlement information. Transfer of the settlement information to the settlement device is performed so as to make the settlement device perform a settlement processing. In other words, the buttons B4-B7 are selection buttons each of which accepts an operation by the employee 2-1 for selecting any of the four settlement devices 12 as a settlement device which is made to perform the settlement processing. The settlement device 12 selected by the above accepted operation performs a settlement processing based on the settlement information, in accordance with an operation of a shopper. The CPU 11a makes a message to urge the employee 2-1 to select a payment method, or to select a transfer destination of the settlement information, such as a character string “select payment method or select transfer destination” to be displayed, in a message display area in the vicinity of the button B3. The button B8 is a button which accepts an operation by the employee 2-1 for designating to return the screen of the touch panel 11g from the first selection screen SC2 to the registration screen SC1 to display the registration specification. In the button B8, a character string “return to registration specification”, for example, is displayed.

When the CPU 11a confirms that the semi-self mode is ON (YES in Act7) in the above-described Act7, the processing of the CPU 11a proceeds to Act9. In Act9, the CPU 11a controls the touch panel 11g, to make a second selection screen SC3 to be displayed in a part of the region of the screen of the touch panel 11g.

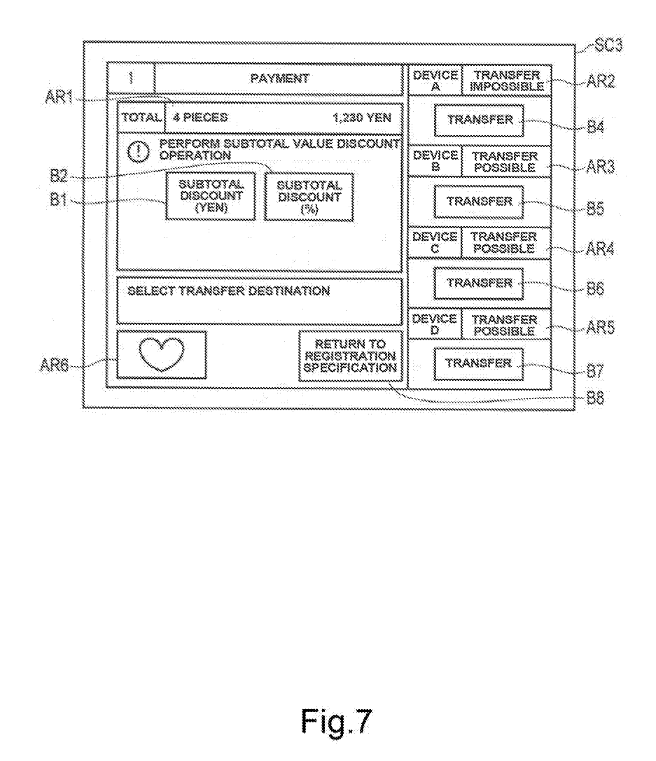

FIG. 7 is a diagram showing the second selection screen SC3 as an example in the present embodiment. The second selection screen SC3 is a selection screen when the semi-self mode is ON (when the cashier mode is OFF). With a configuration described below, the second selection screen SC3 accepts an operation by the employee 2-1 for selecting the settlement device 12 which is made to perform a settlement processing. In addition, in FIG. 7, the same symbols are given to same elements as in FIG. 6, and the detailed description thereof will be omitted.

The second selection screen SC3 includes the display areas AR1, AR2, AR3, AR4, AR5, AR6 and the buttons B1, B2, B4, B5, B6, B7, B8.

That is, the second selection screen SC3 is a screen which does not include the button B3 in the first selection screen SC2. In other words, the second selection screen SC3 is a screen which cannot accept an operation by the employee 2-1 for designating a selection processing of a payment method of a price of the purchased commodity. The CPU 11a makes a message to urge the employee 2-1 to select a transfer destination of the settlement information, such as a character string “select transfer destination”, to be displayed, in a message display area corresponding to a message display area in the vicinity of the above-described button B3.

After the first or second selection screen SC2, SC3 has been displayed in a part of the region of the screen of the touch panel 11g in the above-described Act8 or Act9, the processing of the CPU 11a proceeds to Act10.

In Act10, the CPU 11a confirms whether or not a commodity code of the purchased commodity which should be subjected to an additional registration processing has been acquired. And when the CPU 11a confirms that a commodity code has not been acquired (NO in Act10), the processing of the CPU 11a proceeds to Act11.

In Act11, the CPU 11a confirms whether or not the settlement device 12 that is a transfer destination of the settlement information has been selected. That is, the CPU 11a confirms whether or not the settlement device 12 that is a transfer destination of the settlement information has been selected, by an operation of the employee 2-1 which each of the buttons B4-B7 accepts. And when the CPU 11a confirms that the settlement device 12, that is a transfer destination of the settlement information, has not been selected (NO in ACt11), the processing of the CPU 11a proceeds to Act12.

In Act12, the CPU 11a confirms whether or not the totalizing operation has been performed. That is, the CPU 11a confirms whether or not the totalizing operation has been performed by an operation of the employee 2-1 which the button B3 accepts. And when the CPU 11 confirms that the totalizing operation has not been performed (NO in Act12), the processing of the CPU 11a returns to Act10.

In this manner, the CPU 11a waits for, in Act10-Act12, that the commodity code is acquired, any of the settlement devices is selected, or the totalizing operation is performed. However, as described above, the totalizing operation is an operation of the button B3 by the employee 2-1, for example. For this reason, when the second selection screen SC3 is displayed in the screen of the touch panel 11g, the button B3 does not exist therein. That is, since the totalizing operation is never performed, the CPU 11a always confirms that the totalizing operation is not performed in Act12 (NO in Act12). Accordingly, the CPU 11a, in the waiting state of Act10-act12, waits for that the commodity code is acquired (Act10), or any of the settlement devices 12 is designated (Act11), if the semi-self mode is ON.

In addition, though illustration is omitted, in the waiting state of the above-described Act10-Act12, the CPU 11a waits for also that the above-described discount is designated. That is, the CPU 11a waits for that the buttons B1, B2 are operated. And any of the buttons B1, B2 is operated by the employee 2-1, and the operation is detected by the touch panel 11g, the CPU 11a changes the total money amount included in the settlement information, in accordance with a subsequent instruction by the employee 2-1.

In the above-described Act10, when the CPU 11a confirms that the commodity code has been acquired (YES in Act10), the processing of the CPU 11a proceeds to Act13.

In Act13, the CPU 11a controls the touch panel 11g, to make the registration screen SC1 to be displayed in a part of the region of the screen of the touch panel 11g. After this, the processing of the CPU 11a proceeds to Act5 of FIG. 3. The CPU 11a repeats the processings of Act5 and later in the same manner as described above.

When the CPU 11a confirms that the settlement device 12 to become a transfer destination of the settlement information has been selected (YES in Act11), in the waiting state of the above-described Act10-Act12, the processing of the CPU 11a proceeds to Act14. As described above, any of the buttons B4-B7 of the first or second selection screen SC2, SC3 is operated by the employee 2-1, and thereby the settlement device 12 is selected.

In addition, even when a button (the button B4 shown in FIG. 6 or FIG. 7, for example) associated with the settlement device 12 which is unable to receive the settlement information, out of the buttons B4-B7, is operated by the employee 2-1, the CPU 11a does not confirm that the settlement device 12 that is a transfer destination has been selected (NO in Act11). That is, the CPU 11a does not accept a selection of the device A that is the settlement device 12 associated with the button B4, in FIG. 6 or FIG. 7, for example. In addition, when the all settlement devices 12 are in an operation stopping state, and when the all settlement devices 12 are in a state unable to receive the settlement information, the CPU 11a does not accept a selection to the all settlement devices 12. That is, in the above-described case, the CPU 11a does not confirm that the settlement device that is a transfer destination has been selected, even when any of the buttons B4-B7 is operated by the employee 1-2 (NO in Act11). In addition, the CPU 11a sets the cashier mode to ON or OFF, based on an operation by the employee 2-1, as described above. For example, when the self-service mode is subjected to an OFF operation by the employee 2-1, the CPU 11a sets the cashier mode to ON. In the state that the cashier mode is ON, that is the semi-self mode is OFF, the CPU 11a makes the first selection screen SC2 to be displayed in the screen of the touch panel 11g. In the first selection screen SC2, as described above, the selection of the payment method and the selection of the settlement device 12 that is a transfer destination of the settlement information by the employee 2-1 can be accepted, but the first selection screen SC2 may be set so as not to accept the selection of the all settlement devices 12.

When the CPU 11a confirms that the settlement device 12 that is a transfer destination of the settlement information has been selected in the above-described Act11 (YES in Act11), in Act14, the CPU 11a selects a mark for each the settlement information to be transferred to the above selected settlement device 12. The commodity registration device 11 stores marks of kinds of the number corresponding to the number of the settlement devices 12 which are arranged in the store as the targets of the transfer destination of the settlement information, in the ROM 11b, for example. When the four settlement devices 12A1, 12A2, 12B1, 12B2 are arranged in the store, as the targets of the transfer destination of the settlement information of the one commodity registration device 11A, for example, the ROM 11b of the commodity registration device 11A previously stores at least four kinds of marks. The CPU 11a selects the four kinds of marks in order, for each the settlement information. By this means, the marks to be transferred to the four settlement devices 12A1, 12A2, 12B1, 12B2 do not overlap with each other.

However, when the number of the above-described settlement devices 12 and the number of kinds of the above-described marks are same, as described above, there is a possibility that the CPU 11a continuously transfers the same mark to the one settlement device 12. Accordingly, so as not to make the shopper 4 confused, it is preferable that the marks of kinds of a number larger than the number of the above-described settlement devices 12 by at least one or more are stored in the ROM 11b. By this means, since the same mark is not continuously transferred to the one settlement device 12, it is possible to give a sense of security to the shopper 4.

In addition, when the four settlement devices 12A1, 12A2, 12B1, 12B2 are arranged in the store, as the targets of the transfer destination of the settlement information of each of the two commodity registration devices 11A, 11B, if the same mark is stored in the ROMs 11b of the two commodity registration devices 11A, 11B, there is a possibility that the same mark is simultaneously used in the two commodity registration devices 11A, 11B. Accordingly, the ROMs 11b of the two commodity registration devices 11A, 11B store a plurality of different kinds of marks, respectively.

In addition, when the number of the commodity registration devices 11 is large, if the marks stored in the ROMs 11b of the respective commodity registration devices 11 are different, the number of kinds of the marks used in the whole system becomes large. If the number of kinds of the marks becomes large, there is a possibility that the discrimination of the mark by the shopper 4 becomes difficult. Accordingly, a plurality of the marks to be used in a plurality of the commodity registration devices 11 are commonly used, and thereby the plurality of commodity registration devices 11 may select the plurality of marks in order. In this case, when one commodity registration device 11 selects a mark, the relevant commodity registration device 11 notifies the other commodity registration devices 11 of the selected mark through the communication unit 11j and the LAN 13. The other commodity registration device 11 selects a mark of a next order, in accordance with this notification. By this means, a plurality of the commodity registration devices 11 never transfer the same mark to a plurality of the settlement devices 12.

In addition, when the number of the commodity registration devices 11 and the settlement devices 12 is large, in a large-scale supermarket and so on, the number of the settlement devices 12 that are the targets of the transfer destination of the settlement information of the one commodity registration device 11 may be limited to the number of the settlement devices 12 installed near the relevant commodity registration device 11. For example, even when the settlement devices 12 are installed by 20, only the five settlement devices 12 installed near the one commodity registration device 11 may be set to the targets of the transfer destination of the settlement information of the relevant commodity registration device 11.

When the CPU 11a selects the above-described mark in the above-described Act14, the processing of the CPU 11a proceeds to Act15. In Act15, the CPU 11a makes the selected mark to be displayed on the touch panel 11g. For example, the CPU 11a makes the mark to be displayed in the display area AR6 of the first selection screen SC2 or the second selection screen SC3 displayed on the touch panel 11g. In addition, in the above-described Act15, the CPU 11a makes a guide screen for guiding a route to the settlement device 12 in which the shopper 4 performs an operation of settlement processing, to be displayed on the display 11mA facing the shopper 4. The settlement device 12 in which the shopper 4 performs an operation for settlement processing is a settlement device to which the settlement information of the purchased commodity of the relevant shopper 4 has been transferred.

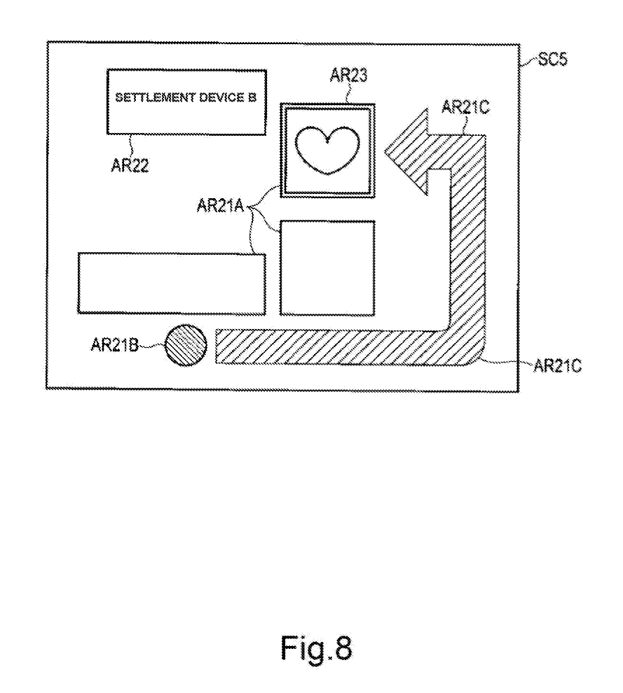

FIG. 8 is a diagram showing a guide screen SC5 to be displayed on the display 11mA as an example in the present embodiment. The guide screen SC5 shown in FIG. 8 is a screen which displays layout images showing arrangements of the commodity registration device 11A and the settlement devices 12A1, 12A2, and in addition, a route image indicating a route from the commodity registration device 11A to the settlement device 12A2 selected as the transfer destination of the settlement information. Here, the settlement device 12A2 selected as the transfer destination is, in other words, a settlement device in which the shopper performs an operation for settlement processing. The guide screen SC5 includes layout images AR21A showing arrangements of the commodity registration device 11A and the settlement devices 12A1, 12A2, and a name display area AR22 which displays a name of the settlement device 12A2 selected as the transfer destination of the settlement information by the employee 2-1. In FIG. 8, a character string “settlement device B” indicating a device name of the settlement device 12A2 is displayed in the name display area AR22. In addition, in the layout image AR21A, the same mark as the mark displayed in the display area AR6 of the touch panel 11g is displayed, in a display area AR23 corresponding to the settlement device 12A2 (settlement device B) that is the transfer destination of the settlement information.

By this means, the shopper 4A-1, in the guide screen SC5, can easily grasp the position of the settlement device 12, in the layout image AR21A, in which the shopper 4A-1 oneself performs an operation for settlement processing, based on the display of the mark.

Further, the guide screen SC5 displays a shopper mark AR21B indicating a present position of the shopper 4-1, and a route image AR21C indicating a route from the display position of the shopper mark AR21B to the settlement device 12 in which the shopper 4-1 performs an operation for settlement processing.

The CPU 11a makes the shopper mark AR21B to be displayed in the guide screen SC5 in a display form which the shopper 4A-1 can easily discriminate. For example, the CPU 11a makes the shopper mark AR21B to be displayed in a conspicuous display color (red color, for example) different from the background color, or to be flickered, in the guide screen SC5.

In addition, the CPU 11a displays a moving route by the shopper, from a position which the shopper mark AR21B indicates to the settlement device 12A2 in which the shopper 4A-1 performs an operation for settlement processing, so that the shopper 4A-1 can easily discriminate the moving route by the route image AR21C. The CPU 11a may make the route image AR21C to be displayed in the guide screen SC5 by a moving picture (animation). For example, the CPU 11a makes the route image AR21C to be displayed in the guide screen SC5, by a moving picture wherein an arrow-shaped object extends from the vicinity of the shopper mark AR21B to the settlement device 12 in which the shopper performs an operation for settlement processing. In addition, as the moving picture of the route image AR21C, if the shopper 4A-1 can easily grasp the moving route to the settlement device 12, various expression methods other than the above-described method can be used.

In addition, the route image AR21C is not only displayed by a moving picture, but may be displayed by a static image. When the route image AR21C is a static image, the CPU 11a may make the route image AR21C to be displayed, in a conspicuous display color (red color, for example) different from the background color, or to be flickered, in the guide screen SC5. In addition, the CPU 11a can make the route image AR21C to be displayed in the guide screen SC5, by combining a plurality of different display forms.

By this means, the shopper 4-1, in the guide screen SC5, can easily and surely grasp the moving route from the present position (the display position of the shopper mark AR21B) in the layout image AR21A to the settlement position 12 in which the shopper 4-1 oneself performs an operation for settlement processing, based on the display of the route image AR21C.

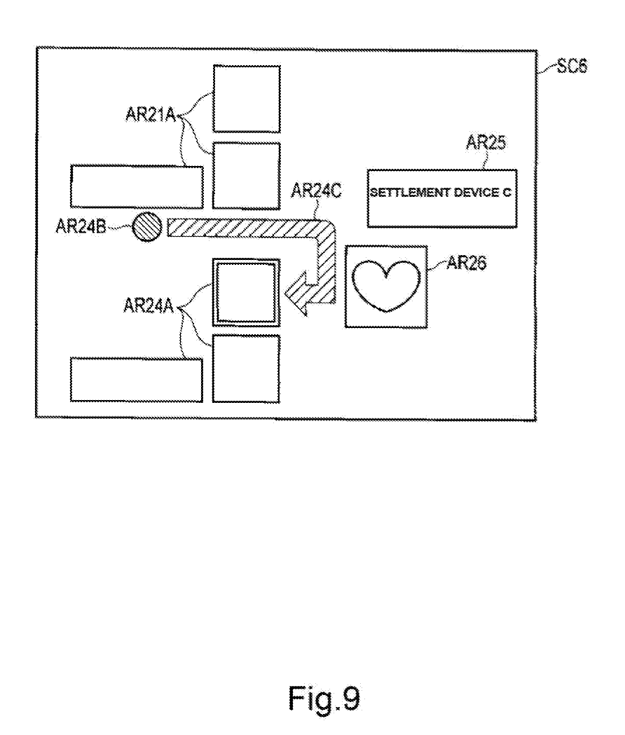

In addition, the guide screen SC5 shown in FIG. 8 indicates a display example in the case of transmitting the settlement information to the settlement device 12A2 installed in the vicinity of the commodity registration device 11A. In contrast, FIG. 9 indicates a display example of a guide screen SC6 in the case of transmitting the settlement information to the settlement device 12B2 installed at a place distant from the commodity registration device 11A. For example, when the settlement processings are being executed by the shoppers 4 in the settlement devices 12A1, 12A2, the employee 2-1 selects the settlement devices 12B1, 12B2 installed in the vicinity of the commodity registration device 11B which is provided next, and can transmit the settlement information thereto. In this case, the CPU 11a of the commodity registration device 11A makes the guide screen SC6 including layout images of the commodity registration device 11B, the settlement devices 12B1, 12B2 to be displayed on the display 11mA.

The guide screen SC6 shown in FIG. 9 includes the layout images AR21A indicating arrangements of the commodity registration device 11A and the settlement devices 12A1, 12A2, layout images AR24A indicating arrangements of the commodity registration device 11B and the settlement devices 12B1, 12B2, and a name display area AR25 which displays a name of the settlement device 12B2 which has been selected as the transfer destination by the employee 2-1. In FIG. 9, a character string “settlement device C” indicating the device name of the settlement device 12B is displayed, in the name display area AR25. In addition, the guide screen SC6 includes a mark display area AR26 which displays the same mark as the mark displayed on the touch panel 11g, in the vicinity of the display area corresponding to the settlement device 12B2 (settlement device C) of the layout image AR24A. The mark display area AR26 is displayed in an area different from the display area corresponding to the settlement device 12B2, in the guide screen SC6, so that the display size of the mark does not become small.

Further, the guide screen SC6 displays a shopper mark AR24B indicating the present position of the shopper 4-1, and a route image AR24C indicating a route from the display position of the shopper mark AR24B to the settlement device 12 in which the shopper 4A-1 performs an operation for settlement processing. In addition, the shopper mark AR24B and the route image AR24C are displayed in the same display form as in the guide screen SC5.

In this manner, the CPU 11a can display the guide screen SC5 and the guide screen SC6 on the display 11ma by switching them, in accordance with the settlement device 12 that is the transfer destination of the settlement information selected by the employee 2-1. Accordingly, the shopper 4A-1 can easily and surely grasp the moving route to the relevant settlement device 12, even when the shopper 4A-1 performs an operation for settlement processing in the settlement devices 12B1, 12B2 installed separately from the commodity registration device 11A.

In Act16, the CPU 11a transfers the settlement information generated in Act6, and the mark selected in Act14 to the settlement device 12 which has been selected by the employee 2-1 using the buttons B4-B7. For example, the CPU 11a controls the communication unit 11j so as to transmit the settlement information and the mark to the LAN 13, by setting the selected settlement device 12 as the destination. In this manner, the CPU 11a determines the settlement device 12 in which the shopper 4-1 is made to perform an operation for settlement processing, in accordance with that any of the buttons B4-B7 has been operated. In addition, the CPU 11a accepts that any of the buttons B4-B7 has been operated, as an instruction of ending of the registration processing of the purchased commodity, and transfers the settlement information to the settlement device 12, in accordance with this.

When the transfer of the settlement information and the mark is completed, the processing of the CPU 11a proceeds to Act17. In Act17, the CPU 11a makes a notification screen to be displayed in a part of the region of the screen of the touch panel 11g.

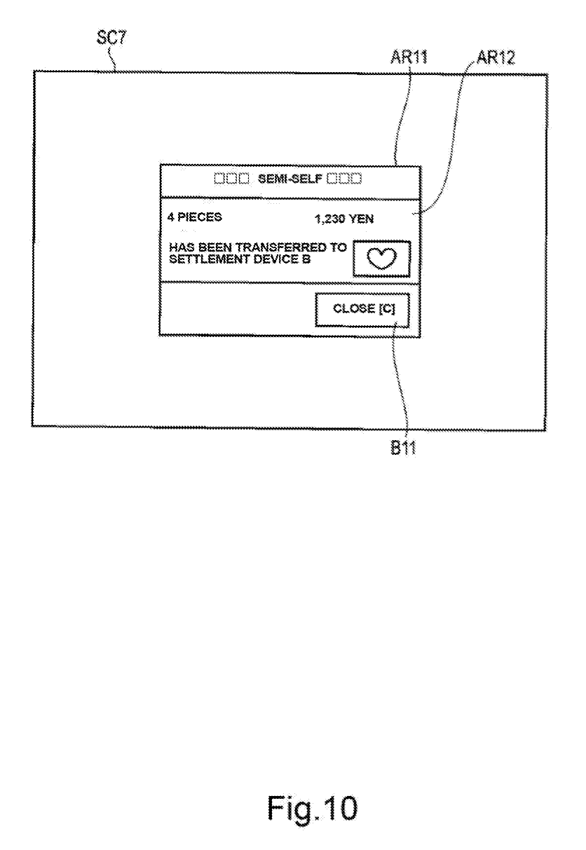

FIG. 10 is a diagram showing a notification screen SC7 as an example in the present embodiment. The notification screen SC7 includes display area AR11, AR12 and a button B11. The button B11 is a button which accepts an operation by the employee 2-1 for instructing to close the notification screen SC7. In the button B11, a character string “close (C)”, for example, is displayed.

The CPU 11a makes an image including a character string “semi-self” so as to make the employee 2-1 recognize that the settlement by the semi-self mode has been selected to be displayed, in the display area AR11 of the notification screen SC7. In addition, the settlement processing by the semi-self mode is a settlement form that the settlement device 12 executes the settlement processing by an operation by the shopper 4, as described above.

The CPU 11a makes the total number (for example, a character string “4 pieces”), the total money amount (for example, a character string “1230 yen”) which are indicated in the settlement information, a message for notifying the employee 2-1 of the settlement device 12 to which the settlement information has been transmitted (for example, a character string “has been transferred to settlement device B”), and the mark transmitted with the settlement information, to be displayed in the display area AR12. Since the mark is displayed in the notification screen SC7, the employee 2-1 can orally inform the shopper 4 of the settlement device 12 in which the shopper 4 performs an operation for settlement processing. For example, the employee 2-1 can inform the shopper 4 of “please perform an operation for settlement processing in the settlement device B in which the heart mark is displayed”.

In accordance with that the button B11 has been touched by the employee 2-1, the processing of the CPU 11a returns to Act1 of FIG. 3, and CPU 11a repeats the subsequent processings in the same manner as described above.

While the state of the CPU 11a is the waiting state of the above-described Act10-Act12, when the CPU 11a confirms, in the above-described Act12, that the totalizing operation has been performed (YES in Act12), the processing of the CPU 11a proceeds to Act18.

In Act18, the CPU 11a executes the settlement processing.

The settlement processing here is a processing in which the employee 2-1 settles the total money amount indicated in the settlement information generated in Act6, while interacting with the shopper 4. As the settlement processing here, for example, the processing which is performed in an existing interactive POS terminal and so on can be applied without change.

Further, in Act19, the CPU 11a controls the printer 11h, and thereby makes the printer 11h issue a receipt expressing the information included in the settlement information generated in Act6 and the result of the above-described settlement processing. And the CPU 11a returns to Act 1 in FIG. 3 after this, and performs the subsequent processings in the same manner as described above.

On the other hand, when the settlement device 12 is started up by an operation of the shopper 4, the CPU 12a starts a control processing for settlement processing, in accordance with the control program stored in the ROM 12b or the auxiliary storage unit 12d.

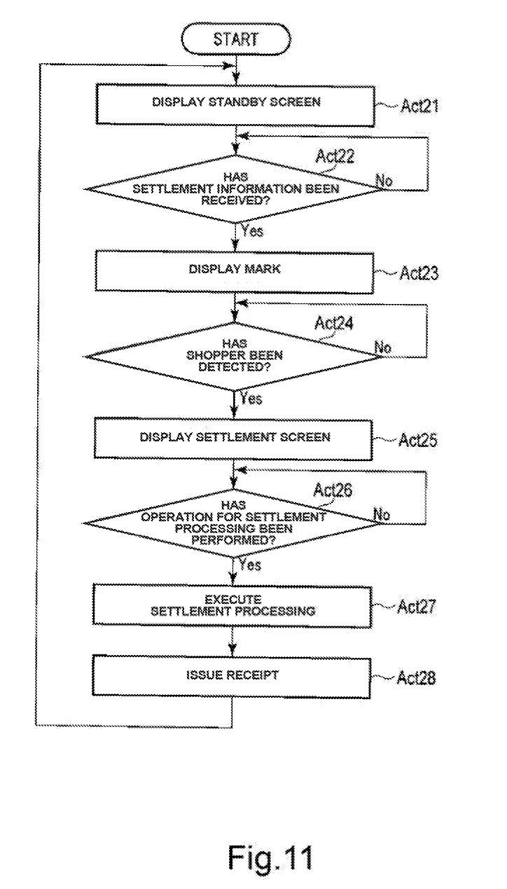

FIG. 11 is a flow chart of a control processing of the CPU 12a in the present embodiment. In Act21, the CPU 12a makes a standby screen to be displayed on the touch panel 12g.

The standby screen indicates that the settlement device 12A1 is not in a state to perform a settlement processing, and what information to be displayed may be optional. For example, the standby screen displays a screen to express a message that the settlement processing cannot be performed, or an optional image representing an advertisement or the like as a screen saver.

In Act22, the CPU 12a confirms whether or not the settlement information has been received. And when confirming that the settlement information has not been received (NO in Act22), the CPU 12a repeats the processing of Act22. In this manner, the CPU 12a waits for that the settlement information is received in Act22.

On the other hand, the communication unit 12j of the settlement device 12A that is a transfer destination receives the settlement information and the mark which have been transferred from the communication unit 11j of the above-described commodity registration device 11A, via the LAN 13. The received settlement information and mark are stored in the RAM 12c or the auxiliary storage unit 12d. According to this, when the CPU 12a confirms that the settlement information has been received (YES in Act22), the processing of the CPU 12a proceeds to Act23.

In Act23, the CPU 12a changes the screen of the touch panel 12gA1 from the above-described standby screen to a display screen of the mark. For example, the CPU 12a makes the same mark as in the guide screen SC5 displayed on the display 11mA of the commodity registration device 11A to be displayed in the above-described display screen of the mark. Accordingly, the shopper 4A-2 moves with reference to a route which the route image AR21C (or the route image AR24C) displayed in the guide screen SC5 (or the guide screen SC6), and thereby can easily confirm the settlement device 12A1 in which the same mark as the mark confirmed in the commodity registration device 11A is displayed. That is, the shopper 4A-1 moves to the settlement device 12A-1 in which the shopper 4A-1 oneself has to perform an operation for settlement processing, based on the moving route confirmed in the route image AR21C (or the route image AR24C) and the mark, and thereby can confirm the settlement device 12-1. In addition, since the kind of the mark is different for each settlement information, the shopper 4A-2 can surely discriminate the content of the settlement processing (accounting) of the own purchased commodity from the kind of the mark, and thereby can perform an operation for settlement processing (accounting processing) at ease.

Further, in Act24, the CPU 12a confirms whether or not the shopper 4 has moved to the settlement device 12. For example, the CPU 12a determines whether or not the shopper 4 who has moved to the settlement device 12 is detected by the touch sensor of the touch panel 12gA1, or a human detection sensor not shown, or the like. The operation of the shopper 4 is detected by the touch sensor of the touch panel 12gA1, or the shopper 4 who has approached the settlement device 12 is detected by the human detection sensor not shown, and thereby the CPU 12a determines that the shopper has moved to the settlement device 12A-1. When it is determined that the shopper 4 has moved to the settlement device 12 (YES in Act24), in Act25, the CPU 12a changes the screen of the touch panel 12g to a settlement screen.

The above-described settlement screen accepts an operation for settlement processing by the shopper 4, based on the settlement information received from the commodity registration device 11. The settlement screen displays the total money amount indicated in the settlement information, for example. In addition, the settlement screen may include a list of the total number and the purchased commodity. In addition, when the settlement processing by a plurality of settlement methods is allowed, the settlement screen includes a button or the like used for the shopper 4 to select the settlement method.

In Act26, the CPU 12a confirms whether or not an operation for settlement processing by the shopper 4 has been performed. And, when determining that the relevant operation has not been performed (NO in Act26), the CPU 12a repeats the processing of Act26. In this manner, the CPU 12a waits for that the operation for settlement processing will be performed, in Act26.

When the CPU 12a determines that the operation for settlement processing has been performed by the shopper (YES in Act26), the processing of the CPU 12a proceeds to Act27. In Act27, the CPU 12a executes the settlement processing. The settlement processing here is a processing for settling the total money amount included in the settlement information stored in the RAM 12c or the auxiliary storage unit 12d. As the settlement processing here, for example, the processing which is performed in an existing self POS terminal and so on can be applied without change.

Further, in Act28, the CPU 12a controls the printer 12h, to make the printer 12h issue a receipt expressing the information included in the settlement information stored in the RAM 12c or the auxiliary storage unit 12d, and the result of the above-described settlement processing. And the CPU 12a returns to Act21, and performs the subsequent processings in the same manner as described above.

As described above, according to the checkout system 10 in the present embodiment, the employee 2-1 can select in which one of the commodity registration device 11 and the settlement device 12, the settlement processing is to be performed, after the completion of the registration of the purchased commodity by the commodity registration device 11. When it is selected by the employee 2-1 to perform the settlement processing in the settlement device 12, the commodity registration device 11 displays the guide screens SC5, SC6 including the route image of the moving picture (animation) and so on indicating the moving route of the shopper 4 to the settlement device 12 in the layout images of respective devices, on the display 11mA. The commodity registration device 11 displays the guide screens SC5, SC6, and thereby can guide the shopper 4 to the settlement device 12 in which the shopper 4 oneself performs the settlement processing. The shopper 4 confirms the guide screen SC5, SC6, and thereby can move easily and surely to the settlement device 12 in which the shopper 4 oneself performs an operation for settlement processing.

In addition, an operation for settlement processing by the shopper 4 takes a long time, and the all settlement devices 12 may be during a settlement processing (accounting). In this case, the commodity registration device 11 cannot transfer the settlement information to any settlement device 12. In such a case, the employee 2-1 operates the commodity registration device 11, to make the commodity registration device 11 perform the settlement processing. By this means, the employee 2-1 never makes the shopper 4 wait until the settlement device 12 becomes vacant, after the completion of the registration processing of the purchased commodity by the commodity registration device 11. That is, the employee 2-1 selects the settlement processing by the commodity registration device 11 while interacting with the shopper 4, and thereby can provide an advanced service to the shopper. In this case, the commodity registration device 11 does not display the guide screen SC5, but displays a screen relating to the settlement processing, on the display 11mA.

In addition, according to the checkout system 10, the semi-self mode is maintained in an ON state, and thereby it is possible to operate the checkout system 10 such that the settlement processing is performed by only the settlement device 12.

In the above-described embodiment, the following various modifications are enabled. In the above-described embodiment, the CPU 11a accepts an operation to any of the buttons B4-B7 by the employee, as the selection to perform the settlement processing in the settlement device 12, and the designation of ending of the registration processing of the purchased commodity. And the above-described accepting term of the CPU 11a is determined as a term from a time when the subtotal button is touched till any of the buttons B3-B7 is touched. But, the CPU 11a accepts touching of any of the buttons B4-B7 as the selection to perform the settlement processing in the settlement device 12, and may accept an operation to a separately prepared button as the designation of ending of the registration processing. After an operation to any of the buttons B4-B7 has been performed by the employee, the CPU 11a transfers the settlement information to the settlement device 12 which is associated with the operated button, in accordance with that the end button has been operated by the employee.

Or the CPU 11a accepts an operation to a semi-self button which is separately prepared, for selection to make the settlement device 12 perform the settlement processing, as a selection to make the settlement device 12 perform the settlement processing, and may accept an operation to any of the buttons B4-B7 as the designation of ending of the registration processing. After an operation to the semi-self button has been performed by the employee, the CPU 11a transfers the settlement information to the settlement device 12 which is associated with the operated button, in accordance with that any of the buttons B4-B7 has been operated by the employee. In this case, an accepting term when the CPU 11a accepts a selection to make the settlement device 12 perform the settlement processing, can be set to a term which is after starting the registration processing of the purchased commodity, and till the designation of ending of the registration processing is made, or to a partial term within the term.

In addition, the processing of the above-described embodiment can be provided to various devices, with being written in a storage medium, as a computer executable program. For example, the storage medium includes a magnetic disk (a flexible disk, a hard disk, and so on), an optical disk (a CD-ROM, a DVD and so on), a semiconductor memory, and so on. In addition, the above-described program for the processing of the embodiment can be provided to various devices with being transmitted by a communication medium. A computer reads the program stored in the storage medium, or receives the program via the communication medium, and an operation is controlled by this program, and thereby the computer executes the above-described processing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A checkout system comprising:
a commodity registration device configured to perform a registration processing of one or more commodities to be purchased by a customer; and
a plurality of settlement devices each configured to perform a settlement processing of the one or more commodities registered by the registration processing of the commodity registration device;
the commodity registration device having:
an input interface configured to receive an input selecting one of the plurality of settlement devices;
a display configured to display information relating to the registration processing; and
a processor configured to control the display to display a guide screen including a layout image indicating a position of the commodity registration device and a position of each of the plurality of settlement devices, and a route image indicating a route from a position corresponding to the commodity registration device to the position of the selected settlement device.

2. The checkout system according to claim 1, wherein:
the processor is configured to generate settlement information for the settlement processing based on commodity information of each of the one or more commodities registered by the registration processing.

3. The checkout system according to claim 2, wherein:
the commodity registration device has a communication unit configured to communicate with the plurality of settlement devices; and
the processor is configured to
control the communication unit to transfer the settlement information to the selected settlement device if the input is received, and
perform the settlement processing of the commodity registered by the registration processing, if the input is not received.

4. The checkout system according to claim 1, wherein:
the processor is configured to control the layout image displayed on the display to be different based on the selected settlement device.

5. The checkout system according to claim 4, wherein:
the processor is configured to control the layout image displayed on the display based on data corresponding to a distance between the commodity registration device and the selected settlement device.

6. The checkout system according to claim 1, wherein:
the route image is a moving picture.

7. The checkout system according to claim 3, wherein:
the commodity registration device has a memory which previously stores a plurality of object images; and
the processor is configured to
select one of the object images stored in the memory,
control the communication unit to transmit the selected object image along with the settlement information to the selected settlement device, and
control the display to display the selected object image included in the guide screen.

8. A commodity registration device in a checkout system comprising:
an input interface configured to receive an input selecting one of a plurality of settlement devices which performs a settlement processing of a purchase commodity;
a display; and
a processor configured to control the display to display a guide screen including a layout image indicating a position of the commodity registration device and a position of each of the plurality of settlement devices, and a route image indicating a route from a position corresponding to the commodity registration device to the position of the selected settlement device.

9. The commodity registration device according to claim 8, further comprising a communication unit configured to communicate with the settlement devices, wherein:
the processor is configured to
generate settlement information for the settlement processing based on commodity information of the pluralities of commodities registered by the registration processing,
control the communication unit to transfer the settlement information to the selected settlement device, if the input is received, and
perform the settlement processing of the commodity registered by the registration processing, if the input is not received.

10. A method of controlling a commodity registration device in a checkout system, comprising:
performing a registration processing of a plurality of commodities purchased by a customer;
generating settlement information for a settlement processing of the commodity registered by the registration processing;
receiving an input selecting one of a plurality of settlement devices, each of the plurality of settlement devices being configured to perform the settlement processing based on the settlement information;
transferring the settlement information to the selected settlement device selected by the accepted operation; and
displaying a guide screen including a layout image indicating a position of the commodity registration devices and a position of each of the settlement devices, and a route image indicating a route from a position corresponding to the commodity registration device to the position of the selected settlement device.
